(19) United States
(12) Patent Application Publication
(10) Pub. No.: US 2020/0028215 A1
(43) Pub. Date: Jan. 23, 2020

(54) ALL-SOLID-STATE LITHIUM ION SECONDARY BATTERY

(71) Applicant: TDK CORPORATION, Tokyo (JP)

(72) Inventors: Hiroshi SATO, Tokyo (JP); Keiko TAKEUCHI, Tokyo (JP); Masayuki MUROI, Tokyo (JP); Taisuke MASUKO, Tokyo (JP); Hisaji OYAKE, Tokyo (JP); Tomohiro YANO, Tokyo (JP)

(73) Assignee: TDK CORPORATION, Tokyo (JP)

(21) Appl. No.: 16/485,074

(22) PCT Filed: Mar. 29, 2018
(86) PCT No.: PCT/JP2018/013114

§ 371 Date: Aug. 9, 2019

(30) Foreign Application Priority Data
Mar. 31, 2017 (JP) 2017-069454

(51) Int. Cl. H01M 10/0585; H01M 10/0525; H01M 4/66; H01M 10/0562

(52) U.S. Cl. CPC H01M 10/0585; H01M 10/0525; H01M 2300/0071; H01M 10/0562; H01M 4/661

(57) ABSTRACT

An all-solid-state lithium ion secondary battery includes a plurality of electrode layers that are laminated with a solid electrolyte layer therebetween, a current collector layer and an active material layer being laminated in each of the electrode layers, the current collector layers contain Cu, and Cu-containing regions are formed at grain boundaries that are present near the current collector layer among grain boundaries of particles that form the active material layer.

### TECHNICAL FIELD

The present invention relates to an all-solid-state lithium ion secondary battery.

The application is based upon and claims the benefit of priority from Japanese Patent Application No. 2017-69454, filed Mar. 31, 2017, the entire contents of which are incorporated herein by reference.

### BACKGROUND ART

Lithium ion secondary batteries have been widely used as power sources for small mobile devices such as mobile phones, laptop personal computers (PC), mobile information terminals (such as personal digital assistants (PDA)), for example. Lithium ion secondary batteries that are used in small mobile devices have been required to have reduced sizes, reduced thicknesses, and improved reliability.

In the related art, lithium ion secondary batteries using organic electrolyte solutions as electrolytes and lithium ion secondary batteries using solid electrolytes are known as lithium ion secondary batteries. Lithium ion secondary batteries using solid electrolytes as electrolytes (all-solid-state lithium ion secondary batteries) have advantages such as a high degree of freedom in designing battery shapes, easy reduction in size and thickness, and high reliability due to no leakage of electrolytes.

As all-solid-state lithium ion secondary batteries, there is one disclosed in Patent Document 1, for example. Patent Document 1 discloses a lithium ion secondary battery that has a structure in which an active material is carried by an electroconductive matrix of a positive electrode layer and/or a negative electrode layer that are electroconductive materials and that has an area ratio within a range of 20:80 to 65:35 between the active material and the electroconductive materials in a section of the positive electrode layer and/or the negative electrode layer. According to the lithium ion secondary battery disclosed in Patent Document 1, it is possible to prevent the active material and the electroconductive materials from peeling off due to expansion and contraction caused by charging and discharging.

### CITATION LIST

### Patent Literature

### Patent Document 1

International Publication No. 2008/099508

### SUMMARY OF INVENTION

### Technical Problem

However, a sufficient bonding strength is not achieved between a current collector layer and an active material layer that is formed so as to be in contact with the current collector layer in such an all-solid-state lithium ion secondary battery in the related art. Therefore, the current collector layer and the active material layer tend to peel off due to change in volume that accompanies charging and discharging, and sufficient cycling characteristics are not achieved.

The invention was made in view of the aforementioned problems, and an object thereof is to provide an all-solid-state lithium ion secondary battery with satisfactory cycling characteristics.

### Solution to Problem

The inventors conducted intensive research in order to solve the aforementioned problems.

As a result, the inventors found that it is only necessary to form Cu-containing regions at grain boundaries that are present near a current collector layer among grain boundaries of particles that form an active material layer by using a material containing Cu as a material for the current collector layer and controlling sintering conditions when a layered body including the current collector layer and the active material layer disposed so as to be in contact with the current collector layers are formed. Also, the inventors confirmed that satisfactory cycling characteristics are obtained by forming the Cu-containing regions in the active material layer and realized the invention.

That is, the invention relates to the following invention.

According to an aspect of the invention, there is provided an all-solid-state lithium ion secondary battery including: a plurality of electrode layers that are laminated with a solid electrolyte layer therebetween, a current collector layer and an active material layer being laminated in each of the electrode layers, in which the current collector layers contain Cu, and Cu-containing regions are formed at grain boundaries that are present near the current collector layer among grain boundaries of particles that form the active material layer.

In the all-solid-state lithium ion secondary battery according to the aforementioned aspect, the current collector layer may contain at least one selected from the group consisting of V, Fe, Ni, Co, Mn, and Ti.

In the all-solid-state lithium ion secondary battery according to the aforementioned aspect, a shortest distance between; a border of the current collector layer and the active material layer and a Cu-containing region, which extends from the border toward a side of the active material layer and formed in a furthest location from the boundary may be equal to or greater than 0.1 μm and less than a half of the distance between adjacent current collector layers.

In the all-solid-state lithium ion secondary battery according to the aforementioned aspect, the solid electrolyte layer may contain a compound represented by Formula (1) below:

Li_{f}V_{g}AlₕTiᵢPⱼO₁₂ (1)

wherein f, g, h, i, and j in Formula (1) represent numbers that satisfy 0.5≤f≤3.0, 0.01≤g<1.00, 0.09<h≤0.30, 1.40<i≤2.00, and 2.80≤j≤3.20, respectively.

In the all-solid-state lithium ion secondary battery according to the aforementioned aspect, at least one electrode layer may include an active material layer that contains a compound represented by Formula (2) below:

LiₐV_{b}Al_{c}Ti_{d}PₑO₁₂ (2)

wherein a, b, c, d, and e in Formula (2) represent numbers that satisfy 0.5≤a≤4.0, 1.20<b≤2.00, 0.01≤c<0.06, 0.01≤d<0.60, and 2.80≤e≤3.20, respectively.

In the all-solid-state lithium ion secondary battery according to the aforementioned aspect, a relative density of the electrode layer and the solid electrolyte layer may be equal to or greater than 80%.

### Advantageous Effects of Invention

The all-solid-state lithium ion secondary battery according to the invention has satisfactory cycling characteristics. This is thought to be because strong bonding is achieved between the current collector layer and the active material layer since the current collector layer contain Cu and the Cu-containing regions are formed at the grain boundaries that are present near the current collector layer among the grain boundaries of the particles that form the active material layer in the all-solid-state lithium ion secondary battery according to the invention.

### BRIEF DESCRIPTION OF DRAWINGS

FIG. 1 is a schematic sectional view of an all-solid-state lithium ion secondary battery according to a first embodiment.

FIG. 2 is a scanning electron microscope (SEM) photo of an all-solid-state battery in Example 2.

FIG. 3 is an enlarged photo showing a part of FIG. 2 in an enlarged manner.

FIG. 4A is a photo of a field of view when grain boundaries of a second layer that is present near a third layer in a cut surface is observed after a specimen after a heat treatment is cut.

FIG. 4B is a photo showing a Cu mapping result of cutting a specimen after a heat treatment and performing energy dispersive X-ray spectroscopy (EDS) on grain boundaries of a second layer that is present near a third layer in a cut surface.

FIG. 4C is a photo showing a V mapping result of cutting a specimen after a heat treatment and performing energy dispersive X-ray spectroscopy (EDS) on grain boundaries of a second layer that is present near a third layer in a cut surface.

FIG. 4D is a photo showing an Al mapping result of cutting a specimen after a heat treatment and performing energy dispersive X-ray spectroscopy (EDS) on grain boundaries of a second layer that is present near a third layer in a cut surface.

FIG. 4E is a photo showing a Ti mapping result of cutting a specimen after a heat treatment and performing energy dispersive X-ray spectroscopy (EDS) on grain boundaries of a second layer that is present near a third layer in a cut surface.

FIG. 4F is a photo showing a P mapping result of cutting a specimen after a heat treatment and performing energy dispersive X-ray spectroscopy (EDS) on grain boundaries of a second layer that is present near a third layer in a cut surface.

FIG. 5 is a scanning electron microscope (SEM) photo of the same field of view of a specimen after a heat treatment as those in FIGS. 4A to 4F.

FIG. 6 is an enlarged photo showing a part of FIG. 5 in an enlarged manner.

FIG. 7 is a graph showing elemental analysis results at a position represented with circles in FIG. 6.

### DESCRIPTION OF EMBODIMENTS

Hereinafter, the invention will be described in detail while appropriately referring to the drawings. The drawings used in the following description may show characteristic portions in an enlarged manner for the purpose of convenience for easy understanding of characteristics of the invention. Therefore, dimensional ratios and the like of the respective components shown in the drawings may differ from actual dimensional ratios and the like. Materials, dimensions, and the like in the following description are just exemplary examples, and the invention is not limited thereto and can be realized by being appropriately changed without changing the gist thereof.

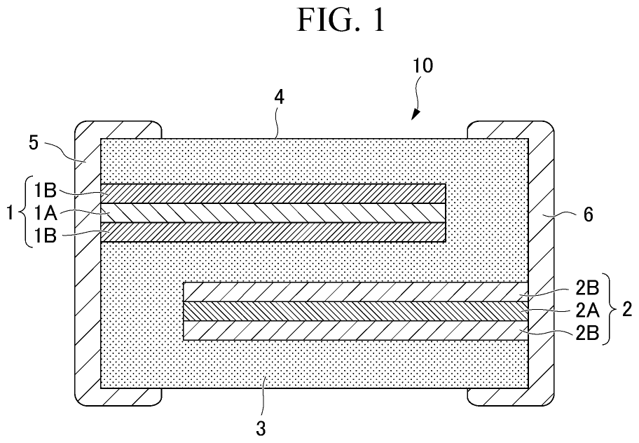

FIG. 1 is a schematic sectional view of an all-solid-state lithium ion secondary battery according to a first embodiment. An all-solid-state lithium ion secondary battery (hereinafter, also abbreviated as an “all-solid-state battery”) 10 shown in FIG. 1 includes a layered body 4, a first external terminal 5 (terminal electrode), and a second external terminal 6 (terminal electrode).

### (Layered Body)

The layered body 4 is adapted such that a plurality of (two layers in FIG. 1) electrode layers 1 (2) are laminated with a solid electrolyte layer 3 therebetween, a current collector layer 1A (2A) and an active material layers 1B (2B) being laminated in each of the electrode layers.

Either one of the two electrode layers 1 and 2 functions as a positive electrode layer, or the other one of them functions as a negative electrode layer. The positive and negative poles of the electrode layers change depending on which of polarities is connected to the terminal electrodes (the first external terminal 5 and the second external terminal 6).

Hereinafter, the electrode layer represented with a reference numeral 1 in FIG. 1 is assumed to be a positive electrode layer 1, and the electrode layer represented with a reference numeral 2 is assumed to be a negative electrode layer 2 for easy understanding.

The positive electrode layer 1 and the negative electrode layer 2 are alternately laminated with the solid electrolyte layer 3 therebetween. The all-solid-state battery 10 is charged and discharged through exchange of lithium ions between the positive electrode layer 1 and the negative electrode layer 2 via the solid electrolyte layer 3. Each of the numbers of the positive electrode layers 1 and the negative electrode layers 2 may be one or more.

### “Positive Electrode Layer and Negative Electrode Layer”

The positive electrode layer 1 has a positive electrode current collector layer 1A and a positive electrode active material layer 1B that contains a positive electrode active material. The negative electrode layer 2 has a negative electrode current collector layer 2A and a negative electrode active material layer 2B that contains a negative electrode active material.

The positive electrode current collector layer 1A and the negative electrode current collector layer 2A contain Cu. Cu is unlikely to react with a positive electrode active material, a negative electrode active material, and a solid electrolyte. Therefore, it is possible to reduce an internal resistance of the all-solid-state battery 10 if the positive electrode current collector layer 1A and the negative electrode current collector layer 2A contain Cu.

The positive electrode current collector layer 1A and the negative electrode current collector layer 2A preferably contain at least one selected from the group consisting of V, Fe, Ni, Co, Mn, and Ti in addition to Cu. In a case in which the positive electrode current collector layer 1A and the negative electrode current collector layer 2A contain these elements, oxidation and reduction of Cu contained in the material of the positive electrode current collector layer 1A or the negative electrode current collector layer 2A are promoted by oxidation and reduction of the aforementioned elements that occur during sintering for forming the layered body 4. As a result, the Cu-containing regions tend to be formed at grain boundaries of particles that form the positive electrode active material layer 1B and/or the negative electrode active material layer 2B that are present near the positive electrode current collector layer 1A and/or the negative electrode current collector layer 2A.

The amount of at least one selected from the group consisting of V, Fe, Ni, Co, Mn, and Ti contained in the positive electrode current collector layer 1A and the negative electrode current collector layer 2A is preferably 0.4 to 12.0% by mass, for example. If the amount of the aforementioned elements is equal to or greater than 0.4 to 12.0% by mass, a significant effect of promoting formation of the Cu-containing regions in the sintering for forming the layered body 4 exhibited.

Note that materials that are included in the positive electrode current collector layer 1A and the negative electrode current collector layer 2A may be the same or different from each other.

The positive electrode active material layer 1B is formed on one surface or both surfaces of the positive electrode current collector layer 1A. In a case in which the positive electrode layer is formed on the uppermost layer of the layered body 4 in a lamination direction of the positive electrode layer 1 and the negative electrode layer 2, no facing negative electrode layer 2 is present on the positive electrode layer 1 located on the uppermost layer. Therefore, the positive electrode active material layer 1B may be provided only on one surface on the lower side in the lamination direction in the positive electrode layer 1 located on the uppermost layer.

The negative electrode active material layer 2B is also formed on one surface or both surfaces of the negative electrode current collector layer 2A similarly to the positive electrode active material layer 1B. In a case in which the negative electrode layer 2 is formed on the lowermost layer of the layered body 4 in the lamination direction among the positive electrode layer 1 and the negative electrode layer 2, the negative electrode active material layer 2B may be provided only on one surface on the upper side in the lamination direction in the negative electrode layer 2 located on the lowermost layer.

In the embodiment, Cu-containing regions, which will be described later, are formed at grain boundaries that are present near the positive electrode current collector layer 1A among grain boundaries of particles that form the positive electrode active material layer 1B and the grain boundaries that are present near the negative electrode current collector layer 2A among the grain boundaries of particles that form the negative electrode active material layer 2B.

The positive electrode active material layer 1B contains a positive electrode active material that exchanges electrons and may contain an electroconductive aid and/or a binder and the like. The negative electrode active material layer 2B contains a negative electrode active material that exchanges electrons and may contain an electroconductive aid and/or a binder and the like. The positive electrode active material and the negative electrode active material may be suitably adapted such that lithium ions can be efficiently inserted and desorbed.

As the positive electrode active material and the negative electrode active material, a transition metal oxide or a transition metal composite oxide, for example, is preferably used. Specifically, it is possible to use a compound represented as LiₐV_{b}Al_{c}Ti_{d}PₑO₁₂ (a, b, c, d, and e are numbers that satisfy 0.5≤a≤3.0, 1.20<b≤2.00, 0.01≤c<0.06, 0.01≤d<0.60, and 2.80≤e≤3.20, respectively), a lithium-manganese composite oxide Li₂MnₖMa₁₋ₖO₃ (0.8≤k≤1, Ma=Co, Ni), lithium cobaltate (LiCoO₂), lithium nickelate (LiNiO₂), lithium manganese spinel (LiMn₂O₄), a composite metal oxide represented as LiNiₓCo_{y}Mn_{z}O₂ (x+y+z=1, 0≤x≤1, 0≤y≤1, 0≤z≤1), a lithium vanadium compound (LiV₂O₅), olivine-type LiMbPO₄ (where Mb is one or more elements selected from Co, Ni, Mn, Fe, Mg, Nb, Ti, Al, and Zr), lithium vanadium phosphate (Li₃V₂(PO₄)₃ or LiVOPO₄), an Li excess solid solution represented as Li₂MnO₃-LiMcO₂ (Mc=Mn, Co, Ni), lithium titanate (Li₄Ti₅O₁₂), a composite metal oxide represented as LiₛNiₜCoᵤAlᵥO₂ (0.9<s<1.3, 0.9<t+u+v<1.1), or the like.

Among them, the positive electrode active material 1B and/or the negative electrode active material layer 2B preferably contains a compound represented by a formula: LiₐV_{b}Al_{c}Ti_{d}PₑO₁₂ (a, b, c, d, and e are numbers that satisfy 0.5≤a≤3.0, 1.20<b≤2.00, 0.01≤c<0.06, 0.01≤d<0.60, and 2.80≤e≤3.20, respectively), in particular. In a case in which the positive electrode active material layer 1B and/or the negative electrode active material layer 2B contains the aforementioned compound, oxidation and reduction of Cu contained in the material of the positive electrode current collector layer 1A or the negative electrode current collector layer 2A are promoted by oxidation and reduction of V that occur during sintering for forming the layered body 4. As a result, the Cu-containing regions tend to be formed at the grain boundaries of the particles that form the positive electrode active material layer 1B and/or the negative electrode active material layer 2B that is present near the positive electrode current collector layer 1A and/or the negative electrode current collector layer 2A.

The negative electrode active material and the positive electrode active material may be selected in accordance with an electrolyte used for the solid electrolyte layer 3, which will be described later.

In a case in which a compound represented as a formula: Li_{f}V_{g}AlₕTiᵢPⱼO₁₂ (f, g, h, i, and j are numbers that satisfy 0.5≤f≤3.0, 0.01≤g<1.00, 0.09<h≤0.30, 1.40<i≤2.00, 2.80≤j≤3.20, respectively) is used as an electrolyte of the solid electrolyte layer 3, for example, it is preferable to use one of or both compounds represented as LiVOPO₄ and LiₐV_{b}Al_{c}Ti_{d}PₑO₁₂ (a, b, c, d, and e satisfy 0.5≤a≤3.0, 1.20<b≤2.00, 0.01≤c<0.06, 0.01≤d<0.60, and 2.80≤e≤3.20, respectively) as the positive electrode active material and the negative electrode active material. In this manner, bonding at an interface of the positive electrode active material layer 1B, the negative electrode active material layer 2B, and the solid electrolyte layer 3 becomes strong.

There is no clear distinction between the active materials that are included in the positive electrode active material layer 1B and the negative electrode active material layer 2B. It is possible to use a compound with a superior potential as a positive electrode active material and to use a compound with an inferior potential as a negative electrode active material by comparing the potentials of the two kinds of compound.

### “Solid Electrolyte Layer”

The electrolyte used for the solid electrolyte layer 3 is preferably a phosphate-based solid electrolyte. As the electrolyte, a material with low electron conductivity and high lithium ion conductivity is preferably used. Specifically, it is possible to use, as an electrolyte, at least one selected from the group consisting of a compound represented by a formula: Li_{f}V_{g}AlₕTiᵢPⱼO₁₂ (f, g, h, i, and j are numbers that satisfy 0.5≤f≤3.0, 0.01≤g<1.00, 0.09<h≤0.30, 1.40<i≤2.00, and 2.80≤j≤3.20, respectively), a Perovskite-type compound such as La_{0.5}Li_{0.5}TiO₃, a Lisicon-type compound such as Li₁₄Zn(GeO₄)₄, a Garnet-type compound such as Li₇La₃Zr₂O₁₂, a Nasicon-type compound such as Li_{1.3}Al_{0.3}Ti_{1.7}(PO₄)₃ or Li_{1.5}Al_{0.5}Ge_{1.5}(PO₄)₃, a thiolisicon-type compound such as Li_{3.25}Ge_{0.25}P_{0.75}S₄ or Li₃PS₄, a glass compound such as Li₂S—P₂S₅ or Li₂O—V₂O₅—SiO₂, and a phosphoric acid compound such as Li₃PO₄, Li_{3.5}Si_{0.5}P_{0.5}O₄, or Li_{2.9}PO_{3.3}N_{0.46}.

The solid electrolyte layer 3 preferably contains the compound represented as the formula: Li_{f}V_{g}AlₕTiᵢPⱼO₁₂ (f, g, h, i, and j are numbers that satisfy 0.5≤f≤3.0, 0.01≤g<1.00, 0.09<h≤0.30, 1.40<i≤2.00, and 2.80≤j≤3.20, respectively), in particular, among the above compounds. In a case in which the solid electrolyte layer 3 contains the aforementioned compound, bonding at the boundary of the positive electrode active material layer 1B, the negative electrode active material layer 2B, and the solid electrolyte layer 3 becomes strong.

Also, in a case in which the active material layer 1B (2B) is formed only on the one surface of the current collector layer 1A (2A), the solid electrolyte layer 3 is formed on the surface of the current collector layer 1A (2A) on a side on which the active material layer 1B (2B) is not formed such that the solid electrolyte layer 3 is in contact with the current collector layer 1A (2A). In a case in which the solid electrolyte layer 3 is formed on one surface of the current collector layer 1A (2A), Cu-containing regions, which will be described later, are formed at grain boundaries that are present near the positive electrode current collector layer 1A and/or the negative electrode current collector layer 2A among grain boundaries of particles that form the solid electrolyte layer 3.

In a case in which the solid electrolyte layer 3 formed on one surface of the current collector layer 1A (2A) contains the compound represented as the formula: Li_{f}V_{g}AlₕTiᵢPⱼO₁₂ (f, g, h, i, and j are numbers that satisfy 0.5≤f≤3.0, 0.01≤g<1.00, 0.09<h≤0.30, 1.40<i≤2.00, and 2.80≤j≤3.20, respectively), oxidation and reduction of Cu contained in the material of the positive electrode current collector layer 1A or the negative electrode current collector layer 2A are promoted due to oxidation and reduction of V that occur during sintering for forming the layered body 4. As a result, the Cu-containing regions tends to be formed at the grain boundaries of the particles that form the solid electrolyte layer 3 that is present near the positive electrode current collector layer 1A and/or the negative electrode current collector layer 2A.

### (Terminal Electrode)

The first external terminal 5 is formed in contact with a side surface of the layered body 4 from which an end surface of the positive electrode layer 1 is exposed. The positive electrode layer 1 is connected to the first external terminal 5. Also, the second external terminal 6 is formed in contact with a side surface of the layered body 4 from which an end surface of the negative electrode layer 2 is exposed. The negative electrode layer 2 is connected to the second external terminal 6. The second external terminal 6 is formed in contact with a side surface that is different from the side surface of the layered body 4 on which the first external terminal 5 is formed. The first external terminal 5 and the second external terminal 6 are electrically connected to the outside.

For the first external terminal 5 and the second external terminal 6, it is preferable to use a material with high electroconductivity. For example, it is possible to use silver, gold, platinum, aluminum, copper, tin, nickel, gallium, indium, alloys thereof, or the like. The first external terminal 5 and the second external terminal 6 may each have a single layer or a plurality of layers.

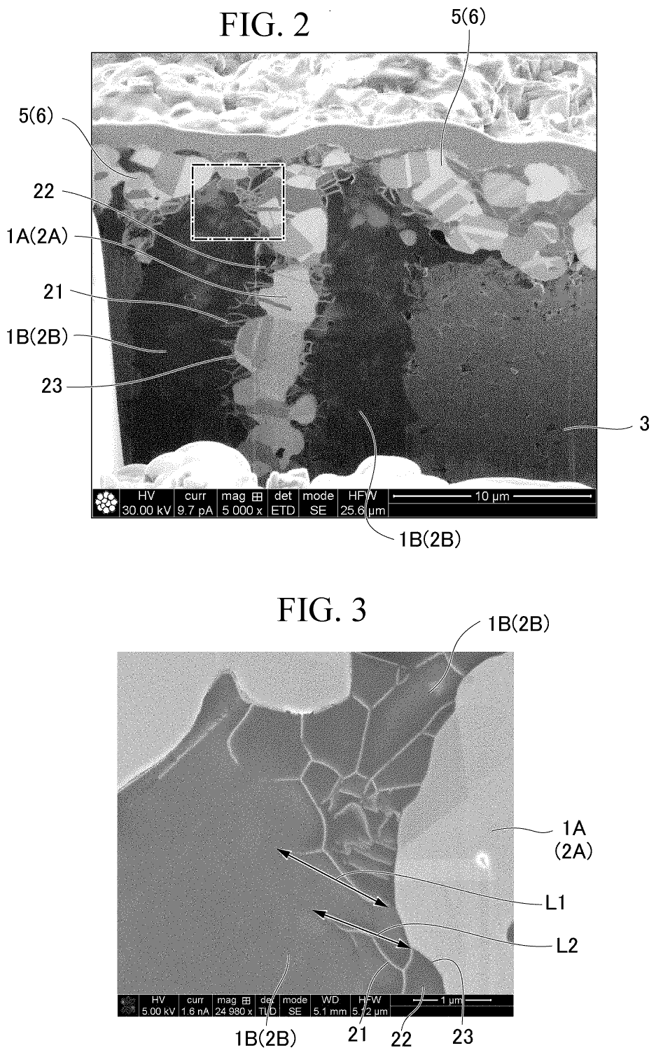

Next, Cu-containing regions formed in the all-solid-state battery 10 according to the embodiment shown in FIG. 1 will be described with reference to FIGS. 2 and 3. FIG. 2 is a scanning electron microscope (SEM) photo of an example of the all-solid-state battery according to the disclosure and is a photo of an all-solid-state battery in Example 2, which will be described later. FIG. 2 is a photo taking a section of a bonding portion between the current collector layer 1A (2A) and the active material layer 1B (2B) in the all-solid-state battery 10. FIG. 3 is an enlarged photo showing a part of FIG. 2 in an enlarged manner and is an enlarged photo in a frame of a dashed line in FIG. 2.

In the all-solid-state battery 10 shown in FIGS. 2 and 3, the Cu-containing regions 21 (the portions in the form of white lines in FIG. 3) are formed at grain boundaries that are present near the current collector layer 1A (2A) among grain boundaries of particles 22 that form the active material layer 1B (2B) of the electrode layer 1 (2). The Cu-containing region 21 is integrated with the current collector layer 1A (2A) and has an anchor effect with respect to the current collector layer 1A (2A).

“Near the current collector layer” means a contact portion between the current collector layer 1A (2A) and the active material layer 1B (2B) (or the solid electrolyte layer 3) including an active material (an active material or a solid electrolyte in a case in which the active material layer 1B (2B) is formed only on one surface of the current collector layer 1A (2A)) in contact with the current collector layer 1A (2A). That is, this disclosure is for enhancing a bonding strength between the current collector layer 1A (2A) and the active material layer 1B (2B) (or the solid electrolyte layer 3) by having a portion (Cu-containing regions 21), at which the current collector layer 1A (2A) and the active material layer 1B (2B) (or the solid electrolyte layer 3) are anchored to each other, at a bonding portion at which the current collector layer 1A (2A) and the active material (or the solid electrolyte) are bonded to each other.

The amount of Cu in the Cu-containing regions 21 are larger than that of the particles 22 that form the active material layer 1B (2B) and the solid electrolyte layer 3.

The amount of Cu in the Cu-containing regions 21 is preferably 50 to 100% by mass and is further preferably 90 to 99% by mass. The effect of enhancing the bonding strength between the current collector layer 1A (2A) and the active material layer 1B (2B) due to the Cu-containing regions 21 is further enhanced as the amount of Cu in the Cu-containing regions 21 increases.

For the Cu-containing regions 21, the shortest distance between a border 23 of the current collector layer 1A (2A) and the active material layer 1B (2B) shown in FIGS. 2 and 3 and the Cu-containing region 21 that extends from the border 23 toward the side of the active material layer 1B (2B) and formed in the furthest location from the boundary is preferably equal to or greater than 0.1 μm and less than a half of the distance between adjacent current collector layers. Further, the aforementioned shortest distance between the border 23 and the Cu-containing region 21 is preferably 1 to 10 μm. If the aforementioned shortest distance is equal to or greater than 0.1 μm, a more significant effect of enhancing the bonding strength between the current collector layer 1A (2A) and the active material layer 1B (2B) due to the inclusion of the Cu-containing regions 21 is exhibited. Therefore, it is possible to effectively prevent the current collector layer 1A (2A) and the active material layer 1B (2B) from peeling off. Also, if the aforementioned shortest distance is less than a half of the distance between the adjacent current collector layers, it is possible to prevent the adjacent current collector layers from being electrically connected to each other and being short-circuited.

The shortest distance between the border 23 and the Cu-containing region 21 that extends from the border 23 toward the side of the active material layer 1B (2B) and formed in the furthest location from the boundary can be measured by observing the section at the bonding portion between the current collector layer 1A (2A) and the active material layer 1B (2B) of the all-solid-state battery 10 using a scanning electron microscope (SEM) at a magnification of 5000-fold, for example.

Specifically, shortest distances L1, L2, . . . connecting both ends of the respective Cu-containing regions 21 that extend from the border 23 of the measurement region toward the side of the active material layer 1B (2B) are measured as shown in FIG. 3. Then, the longest distance among the measured shortest distances L1, L2, . . . is assumed to be the “shortest distance between the border 23 and the Cu-containing region 21 that extends from the border 23 toward the side of the active material layer 1B (2B) and formed in the furthest location from the boundary”.

The length of the border 23 between the current collector layer 1A (2A) and the active material layer 1B (2B) that is required to measure the aforementioned shortest distance is set to be equal to or greater than 200 μm in order to obtain sufficient measurement accuracy.

Also, in a case in which the current collector layer 1A (2A) contains an active material, the grain boundaries of the particles that form the active material in the current collector layer 1A (2A) preferably contain Cu. In this case, bonding at the interface between the current collector layer 1A (2A) and the active material layer 1B (2B) becomes stronger.

Also, an area of the grain boundaries that preferably corresponds to the Cu-containing regions 21 is preferably equal to or greater than 50% and is more preferably equal to or greater than 80% with respect to the area of the grain boundaries of the particles that are present at the interface between the active material layer 1B (2B) and the current collector layer 1A (2A). The anchor effect of the Cu-containing regions 21 with respect to the current collector layer 1A (2A) increases, and the effect of enhancing the bonding strength between the current collector layer 1A (2A) and the active material layer 1B (2B) due to the Cu-containing regions 21 increases, as the proportion of the area of the Cu-containing region 21 with respect to the grain boundaries of the particles that are present at the interface between the active material layer 1B (2B) and the current collector layer 1A (2A) increases.

The proportion of the Cu-containing region 21 with respect to the area of the grain boundaries of the particles that are present at the interface between the active material layer 1B (2B) and the current collector layer 1A (2A) can be calculated by the following method.

The section of the bonding portion between the current collector layer 1A (2A) and the active material layer 1B (2B) of the all-solid-state battery 10 is observed using a scanning electron microscope (SEM) at a magnification of 5000 folds, for example. It is possible to clearly distinguish, from the obtained SEM photo, the interface between the current collector layer 1A (2A) and the active material layer 1B (2B), the grain boundaries of the particles that are present at the interface, and whether or not the grain boundaries are the Cu-containing regions 21. Further, it is possible to confirm whether or not the grain boundaries are the Cu-containing regions 21 through a Cu distribution obtained by performing energy dispersive X-ray spectroscopy (EDS) on the grain boundaries of the particles that are present at the interface between the active material layer 1B (2B) and the current collector layer 1A (2A).

In the embodiment, the sum of lengths at the grain boundaries of the particles that are present at the interface between the current collector layer 1A (2A) and the active material layer 1B (2B) calculated from an SEM photo is regarded as an area of the grain boundaries. Note that the number of particles measured for calculating the aforementioned area of the grain boundaries (the sum of the lengths of the grain boundaries) is preferably equal to or greater than 100, and for accurately calculating the aforementioned area of the grain boundaries, the number of particles is preferably equal to or greater than 300. Also, the sum of the lengths of the grain boundaries that are the Cu-containing regions 21 calculated from the SEM photo in the aforementioned area of the grain boundaries (the sum of the lengths of the grain boundaries) is regarded as an area of the Cu-containing regions 21. Using the thus obtained area of the grain boundaries and the area of the Cu-containing regions 21, the proportion of the area of the Cu-containing regions 21 with respect to the aforementioned area of the grain boundaries is calculated.

### (Method for Manufacturing All-Solid-State Battery)

Next, a method for manufacturing the all-solid-state battery 10 will be described.

The method for manufacturing the all-solid-state battery 10 according to the embodiment includes a laminating process of laminating the plurality of electrode layers 1 (2) in which the current collector layers 1A (2A) and the active material layers 1B (2B) are laminated with a solid electrolyte layer 3 therebetween, thereby forming a layered sheet, a sintering process of sintering the layered sheet, thereby forming the layered body 4, and a terminal formation process of forming the terminal electrodes 5 (6) on the side surface of the layered body 4.

### (Laminating Process)

As a method of forming the layered body 4, a simultaneous burning method may be used, or a sequential burning method may be used.

The simultaneous burning method is a method of laminating materials that form the respective layers and producing the layered body through collective burning. The sequential burning method is a method of producing the respective layers in order and performing a burning process every time each layer is produced. It is possible to form the layered body 4 in a smaller number of operation processes in a case of using the simultaneous burning method than in a case of using the sequential burning method. Also, the obtained layered body 4 becomes finer in the case of using the simultaneous burning method than in the case of using the sequential burning method.

Hereinafter, an exemplary example of a case in which the layered body 4 is manufactured using the simultaneous burning method will be described.

The simultaneous burning method has a process of producing pastes of the respective materials that are included in the layered body 4, a process of producing green sheets using the pastes, and a process of a layered sheet by laminating the green sheets and simultaneously burning the layered sheet.

First, the respective materials for the positive electrode current collector layer 1A, the positive electrode active material layer 1B, the solid electrolyte 3, the negative electrode active material layer 2B, and the negative electrode current collector layer 2A that are included in the layered body 4 are prepared in the form of pastes.

A method of preparing the respective materials in the form of pastes is not particularly limited. For example, pastes may be obtained by mixing powder of the respective materials into vehicles. Here, the vehicles collectively refer to mediums in a liquid phase. The vehicles contain solvents and binders.

The paste for the positive electrode current collector layer 1A, the paste for the positive electrode active material layer 1B, the paste for the solid electrolyte 3, the paste for the negative electrode active material layer 2B, and the paste for the negative electrode current collector layer 2A are produced by such a method.

Then, green sheets are produced. The green sheets are obtained by applying the produced pastes to base materials such as polyethylene terephthalate (PET) films or the like, drying the pastes as needed, and peeling off the base materials.

A method of applying the pastes is not particularly limited. For example, a known method such as screen printing, application, transferring, or a doctor blade can be employed.

Next, the respectively produced green sheets are stacked in accordance with a desired order and the number of layers to be laminated, thereby obtaining a layered sheet. When the green sheets are laminated, alignment, cutting, or the like is performed as needed.

The layered sheet may be produced using a method of producing a positive electrode active material layer unit and a negative electrode active material layer unit, which will be described later and laminating the positive electrode active material layer unit and the negative electrode active material layer unit.

First, the paste for the solid electrolyte 3 is applied to a base material such as a PET film by a doctor blade method and is then dried, thereby forming the solid electrolyte layer 3 in the form of a sheet. Next, the paste for the positive electrode active material layer 1B is printed on the solid electrolyte 3 by screen printing and is then dried, thereby forming the positive electrode active material layer 1B. Then, the paste for the positive electrode current collector layer 1A is printed on the positive electrode active material layer 1B by screen printing and is then dried, thereby forming the positive electrode current collector layer 1A. Further, the paste for the positive electrode active material layer 1B is printed on the positive electrode current collector layer 1A by screen printing and is then dried, thereby forming the positive electrode active material layer 1B.

Thereafter, the PET film is peeled off, thereby obtaining the positive electrode active material layer unit. The positive electrode active material layer unit is a layered sheet in which the solid electrolyte layer 3, the positive electrode active material layer 1B, the positive electrode current collector layer 1A, and the positive electrode active material layer 1B are laminated in this order.

The negative electrode active material layer unit is produced in a similar procedure. The negative electrode active material layer unit is a layered sheet in which the solid electrolyte layer 3, the negative electrode active material layer 2B, the negative electrode current collector layer 2A, and the negative electrode active material layer 2B are laminated in this order.

Next, one positive electrode active material layer unit and one negative electrode active material layer unit are laminated.

At this time, the positive electrode active material layer unit and the negative electrode active material layer unit are laminated such that the solid electrolyte layer 3 in the positive electrode active material layer unit is brought into contact with the negative electrode active material layer 2B in the negative electrode active material layer unit or the positive electrode active material layer 1B in the positive electrode active material layer unit is brought into contact with the solid electrolyte layer 3 in the negative electrode active material layer unit. In this manner, the layered sheet in which the positive electrode active material layer 1B, the positive electrode current collector layer 1A, the positive electrode active material layer 1B, the solid electrolyte layer 3, the negative electrode active material layer 2B, the negative electrode current collector layer 2A, the negative electrode active material layer 2B, and the solid electrolyte layer 3 are laminated in this order is obtained.

Note that when the positive electrode active material layer unit and the negative electrode active material layer unit are laminated, the respective units are stacked in a deviating manner such that the positive electrode current collector layer 1A in the positive electrode active material layer unit extends only toward one end surface and the negative electrode current collector layer 2A in the negative electrode active material layer unit extends only toward the other surface. Thereafter, the sheet for the solid electrolyte layer 3 with a predetermined thickness is further stacked on the surface on a side on which the solid electrolyte layer 3 is not present on the surface although the units are stacked thereon, thereby obtaining a layered sheet.

Next, the layered sheets produced by any of the aforementioned methods are collectively pressure-bonded to each other.

The pressure-bonding is preferably performed while the layered sheets are heated. The heating temperature at the time of the pressure-bonding is set to 40 to 95° C., for example.

### (Sintering Process)

In the sintering process, the layered sheet is sintered, thereby forming the layered body 4. The layered body is heated to 500° C. to 750° C. in a nitrogen, hydrogen, and water vapor atmosphere, for example, to perform debinding. Thereafter, a heat treatment of raising the temperature to a room temperature to 400° C. in an atmosphere of an oxygen partial pressure of 1×10⁻⁵ to 2×10⁻¹¹ atm and heating the layered body at a temperature of 400 to 950° C. in an atmosphere of an oxygen partial pressure of 1×10⁻¹¹ to 133 10⁻²¹ atm is performed in the sintering process. Note that the oxygen partial pressure is a numerical value measured using an oxygen concentration meter at a sensor temperature of 700° C.

In a case in which such a heat treatment is performed, Cu contained in the current collector layer 1A (2A) is diffused as an oxide (Cu₂O) at the grain boundaries of the active material layer 1B (2B) in the process of raising the temperature from room temperature to 400° C. The oxygen partial pressure in the process of raising the temperature from room temperature to 400° C. is preferably 1×10⁻⁵ to 2×10⁻¹¹ atm and is further preferably 1×10⁻⁷ to 5×10⁻¹⁰ atm for promoting the diffusion of Cu₂O.

Cu₂O diffused at the grain boundaries in the process of raising the temperature from room temperature to 400° C. is reduced to metal Cu in the heating process at the temperature of 400 to 950° C. The oxygen partial pressure at the time of the heating at the temperature of 400 to 950° C. is preferably 1×10⁻¹¹ to 1×10⁻²¹ atm and is further preferably 1×10⁻¹⁴ to 5×10⁻²⁰ atm for promoting reduction of Cu₂O.

It is possible to control a range of the grain boundaries at which the Cu-containing regions 21 are formed, by controlling the retention time during which heating is performed at a temperature of 400 to 950° C. in the aforementioned heat treatment. That is, the range of the grain boundaries at which the Cu-containing regions 21 are formed becomes narrower as the retention time in the aforementioned temperature range is shorter, and the range of the grain boundaries at which the Cu-containing regions 21 are formed becomes wider as the retention time in the aforementioned temperature range is longer.

Specifically, it is possible to form the Cu-containing regions 21 that extend from the border 23 between the current collector layer 1A (2A) and the active material layer 1B (2B) to the location of 0.1 to 50 μm at the shortest distance to the side of the active material layer 1B (2B) at the grain boundaries of the particles that form the active material layer 1B (2B) by setting the retention time within the aforementioned temperature range to 0.4 to 5 hours. Also, it is possible to form the Cu-containing regions 21 that extend from the aforementioned border 23 on the location of 1 to 10 μm at the shortest distance to the side of the active material layer 1B (2B) at the aforementioned grain boundary by setting the retention time in the aforementioned temperature range to 1 to 3 hours.

In the embodiment, the Cu-containing regions 21 are formed at the grain boundaries that are present near the current collector layer 1A (2A) among the grain boundaries of the particles that form the active material layer 1B (2B) at the same time as the formation of the layered body 4, by performing the heat treatment such that the temperature and the oxygen partial pressure fall within the aforementioned ranges.

Next, a terminal electrode layer that serves as the terminal electrode 5 (6) is formed and sintered such that the terminal electrode layer is in contact with the side surface of the layered body 4 from which the end surface of the current collector layer 1A (2A) is exposed, thereby forming the terminal electrode 5 (6).

The terminal electrode layers that serve as the first external terminal 5 and the second external terminal 6 can be formed by a known method. Specifically, it is possible to use, for example, a sputtering method, a spray coating method, a dipping method, or the like. In addition, the terminal electrode layers can be sintered under known conditions.

The first external terminal 5 and the second external terminal 6 are formed only at predetermined portions from which the positive electrode current collector layer 1A and the negative electrode current collector layer 2A are exposed in the surface of the layered body 4. Therefore, a region where the first external terminal 5 and the second external terminal 6 are not formed on the surface of the layered body 4 is formed by applying masking using a tape, for example, when the first external terminal 5 and the second external terminal 6 are formed.

Note that although the terminal electrode layers that serve as the first external terminal 5 and the second external terminal 6 are formed and sintered on the side surface of the layered body 4 obtained by sintering the layered sheet and the terminal electrode 5 (6) is thus formed in the aforementioned manufacturing method, the terminal electrode layers may be formed and sintered on the side surface of the layered sheet, and the terminal electrode 5 (6) may be formed at the same time as the layered body 4. In this case, a heat treatment in which the temperature and the oxygen partial pressure are set to be within the aforementioned ranges is performed after the terminal electrode layers are formed on the side surface of the layered sheet.

Since in the thus obtained all-solid-state battery 10, the current collector layer 1A (2A) contains Cu, and the Cu-containing regions 21 are formed at the grain boundaries that are present near the current collector layer 1A (2A) among the grain boundaries of the particles that form the active material layer 1B (2B), satisfactory cycling characteristics are achieved. The effect is estimated to be achieved by bonding between the current collector layer 1A (2A) and the active material layer 1B (2B) with satisfactory bonding strength due to an anchor effect of the Cu-containing region 21 with respect to the current collector layer 1A (2A) of the all-solid-state battery 10.

In the sintered body of the aforementioned layered sheet, the relative density of the electrode layer and the solid electrolyte layer may be equal to or greater than 80%. The diffusion paths of movable ions in a crystal tend to be connected, and ion conductivity is improved as the relative density increases.

Although the embodiments of the invention have been described in detail with reference to the drawings, the respective configurations and the combinations thereof in each embodiment are just examples, and additions, omissions, replacements, and other changes of the configurations can be made without departing from the gist of the invention.

### EXAMPLES

### Examples 1 to 18 and Comparative Example 1

A layered sheet in which the solid electrolyte layer 3, the positive electrode active material layer 1B, the positive electrode current collector layer 1A, the positive electrode active material layer 1B, the solid electrolyte layer 3, the negative electrode active material layer 2B, the negative electrode current collector layer 2A, the negative electrode active material layer 2B, and the solid electrolyte layer 3 were laminated in this order was produced.

Compositions of the positive electrode active material layer 1B, the solid electrolyte layer 3, and the negative electrode active material layer 2B are shown in Tables 1 to 3.

In Examples 2 and 3, Cu that contains 2.0% by mass of current collector layer-containing materials shown in Tables 1 to 3 was used as the materials for the positive electrode current collector layer 1A and the negative electrode current collector layer 2A. Also, Cu was used as the materials for the positive electrode current collector layer 1A and the negative electrode current collector layer 2A in Examples 1 and 4 to 18 and Comparative Example 1.

Next, the produced layered sheet was subject from heat treatment under conditions described below and was sintered, thereby forming the layered body 4.

In Examples 1 to 18, a treatment of raising the temperature from room temperature to 400° C. in an atmosphere of an oxygen partial pressure of 2×10⁻¹⁰ atm, further raising the temperature to 400 to 850° C. in an atmosphere of an oxygen partial pressure of 5×10⁻¹⁵ atm, and performing heating at retention times shown in Tables 1 to 3 in an atmosphere of an oxygen partial pressure of 5×10⁻¹⁵ atm at the temperature of 850° C. was performed as a heat treatment. Note that the oxygen partial pressure was a numerical value measured using an oxygen concentration meter at a sensor temperature of 700° C.

In Comparative Example 1, a treatment of raising the temperature from room temperature to 850° C. in an atmosphere of an oxygen partial pressure of 2×10⁻¹⁰ atm and performing heating in a retention time shown in Table 3 in an atmosphere of an oxygen partial pressure of 2×10⁻¹⁰ atm at a temperature of 850° C. was performed as a heat treatment.

TABLE 1

| | | | | Shortest | Retention time | | | | | | | | |
|---|---|---|---|---|---|---|---|---|---|---|---|---|---|
| | | Cu- | Current collector | distance | at burning | | | | | | | | |
| | | containing | layer-containing | from | temperature | | Composition (% by atom) | | | | | | Cycling |
| | | regions | material | border | (850° C.) | | Li | V | Al | Ti | P | O | characteristics |
| Example 1 | Positive electrode | Present | None | 1 μm | 1 | hour | 2.55 | 1.50 | 0.05 | 0.45 | 3.00 | 12 | B |
| | active material layer | | | | | | | | | | | | |
| | Solid electrolyte | | | | | | 1.00 | 0.05 | 0.12 | 1.70 | 3.00 | 12 | |
| | layer | | | | | | | | | | | | |
| | Negative electrode | | | | | | 2.55 | 1.50 | 0.05 | 0.45 | 3.00 | 12 | |
| | active material layer | | | | | | | | | | | | |
| Example 2 | Positive electrode | Present | LiVOPO₄ | 1 μm | 1 | hour | 0.40 | 1.80 | 0.10 | 1.10 | 2.70 | 12 | A |
| | active material layer | | | | | | | | | | | | |
| | Solid electrolyte | | | | | | 0.45 | 0.30 | 0.15 | 2.10 | 2.75 | 12 | |
| | layer | | | | | | | | | | | | |
| | Negative electrode | | | | | | 0.40 | 1.80 | 0.10 | 1.10 | 2.70 | 12 | |
| | active material layer | | | | | | | | | | | | |
| Example 3 | Positive electrode | Present | LiTi₂(PO₄)₃ | 1 μm | 1 | hour | 2.90 | 2.00 | 0.00 | 0.00 | 3.00 | 12 | A |
| | active material layer | | | | | | | | | | | | |
| | Solid electrolyte | | | | | | 1.00 | 0.05 | 0.12 | 1.70 | 3.00 | 12 | |
| | layer | | | | | | | | | | | | |
| | Negative electrode | | | | | | 2.90 | 2.00 | 0.00 | 0.00 | 3.00 | 12 | |
| | active material layer | | | | | | | | | | | | |
| Example 4 | Positive electrode | Present | None | 0.1 μm | 0.4 | hours | 2.90 | 2.00 | 0.00 | 0.00 | 3.00 | 12 | B |
| | active material layer | | | | | | | | | | | | |
| | Solid electrolyte | | | | | | 1.00 | 0.05 | 0.12 | 1.70 | 3.00 | 12 | |
| | layer | | | | | | | | | | | | |
| | Negative electrode | | | | | | 2.90 | 2.00 | 0.00 | 0.00 | 3.00 | 12 | |
| | active material layer | | | | | | | | | | | | |
| Example 5 | Positive electrode | Present | None | 10 μm | 3 | hours | 2.90 | 2.00 | 0.00 | 0.00 | 3.00 | 12 | B |
| | active material layer | | | | | | | | | | | | |
| | Solid electrolyte | | | | | | 1.00 | 0.05 | 0.12 | 1.70 | 3.00 | 12 | |
| | layer | | | | | | | | | | | | |
| | Negative electrode | | | | | | 2.90 | 2.00 | 0.00 | 0.00 | 3.00 | 12 | |
| | active material layer | | | | | | | | | | | | |
| Example 6 | Positive electrode | Present | None | 50 μm | 5 | hours | 2.90 | 2.00 | 0.00 | 0.00 | 3.00 | 12 | B |
| | active material layer | | | | | | | | | | | | |
| | Solid electrolyte | | | | | | 1.00 | 0.05 | 0.12 | 1.70 | 3.00 | 12 | |
| | layer | | | | | | | | | | | | |
| | Negative electrode | | | | | | 2.90 | 2.00 | 0.00 | 0.00 | 3.00 | 12 | |
| | active material layer | | | | | | | | | | | | |
| Example 7 | Positive electrode | Present | None | 1 μm | 1 | hour | 0.70 | 1.70 | 0.05 | 0.55 | 3.15 | 12 | B |
| | active material layer | | | | | | | | | | | | |
| | Solid electrolyte | | | | | | 0.50 | 0.05 | 0.20 | 2.00 | 2.80 | 12 | |
| | layer | | | | | | | | | | | | |
| | Negative electrode | | | | | | 0.70 | 1.70 | 0.05 | 0.55 | 3.15 | 12 | |
| | active material layer | | | | | | | | | | | | |

TABLE 2

| | | | | Shortest | Retention time at | | | | | | | |
|---|---|---|---|---|---|---|---|---|---|---|---|---|
| | | Cu- | Current collector | distance | burning | | | | | | | |
| | | containing | layer-containing | from | temperature | Composition (% by atom) | | | | | | Cycling |
| | | regions | material | border | (850° C.) | Li | V | Al | Ti | P | O | characteristics |
| Example 8 | Positive electrode | Present | None | 1 μm | 1 hour | 0.50 | 1.85 | 0.04 | 0.55 | 3.10 | 12 | B |
| | active material layer | | | | | | | | | | | |
| | Solid electrolyte | | | | | 1.00 | 0.05 | 0.12 | 1.70 | 3.00 | 12 | |
| | layer | | | | | | | | | | | |
| | Negative electrode | | | | | 0.50 | 1.85 | 0.04 | 0.55 | 3.10 | 12 | |
| | active material layer | | | | | | | | | | | |
| Example 9 | Positive electrode | Present | None | 1 μm | 1 hour | 1.70 | 2.00 | 0.05 | 0.40 | 2.90 | 12 | B |
| | active material layer | | | | | | | | | | | |
| | Solid electrolyte | | | | | 1.00 | 0.05 | 0.12 | 1.70 | 3.00 | 12 | |
| | layer | | | | | | | | | | | |
| | Negative electrode | | | | | 1.70 | 2.00 | 0.05 | 0.40 | 2.90 | 12 | |
| | active material layer | | | | | | | | | | | |
| Example | Positive electrode | Present | None | 1 μm | 1 hour | 2.20 | 1.60 | 0.01 | 0.50 | 3.00 | 12 | B |
| 10 | active material layer | | | | | | | | | | | |
| | Solid electrolyte | | | | | 1.00 | 0.05 | 0.12 | 1.70 | 3.00 | 12 | |
| | layer | | | | | | | | | | | |
| | Negative electrode | | | | | 2.20 | 1.60 | 0.01 | 0.50 | 3.00 | 12 | |
| | active material layer | | | | | | | | | | | |
| Example | Positive electrode | Present | None | 1 μm | 1 hour | 2.60 | 1.90 | 0.04 | 0.01 | 3.10 | 12 | B |
| 11 | active material layer | | | | | | | | | | | |
| | Solid electrolyte | | | | | 1.00 | 0.05 | 0.12 | 1.70 | 3.00 | 12 | |
| | layer | | | | | | | | | | | |
| | Negative electrode | | | | | 2.60 | 1.90 | 0.04 | 0.01 | 3.10 | 12 | |
| | active material layer | | | | | | | | | | | |
| Example | Positive electrode | Present | None | 1 μm | 1 hour | 2.40 | 1.80 | 0.05 | 0.50 | 2.80 | 12 | B |
| 12 | active material layer | | | | | | | | | | | |
| | Solid electrolyte | | | | | 1.00 | 0.05 | 0.12 | 1.70 | 3.00 | 12 | |
| | layer | | | | | | | | | | | |
| | Negative electrode | | | | | 2.40 | 1.80 | 0.05 | 0.50 | 2.80 | 12 | |
| | active material layer | | | | | | | | | | | |
| Example | Positive electrode | Present | None | 1 μm | 1 hour | 2.10 | 1.40 | 0.04 | 0.40 | 3.20 | 12 | B |
| 13 | active material layer | | | | | | | | | | | |
| | Solid electrolyte | | | | | 1.00 | 0.05 | 0.12 | 1.70 | 3.00 | 12 | |
| | layer | | | | | | | | | | | |
| | Negative electrode | | | | | 2.10 | 1.40 | 0.04 | 0.40 | 3.20 | 12 | |
| | active material layer | | | | | | | | | | | |
| Example | Positive electrode | Present | None | 1 μm | 1 hour | 2.55 | 1.50 | 0.05 | 0.45 | 3.00 | 12 | B |
| 14 | active material layer | | | | | | | | | | | |
| | Solid electrolyte | | | | | 0.50 | 0.05 | 0.12 | 1.90 | 3.00 | 12 | |
| | layer | | | | | | | | | | | |
| | Negative electrode | | | | | 2.55 | 1.50 | 0.05 | 0.45 | 3.00 | 12 | |
| | active material layer | | | | | | | | | | | |

TABLE 3

| | | | | Shortest | Retention time | | | | | | | |
|---|---|---|---|---|---|---|---|---|---|---|---|---|
| | | Cu- | Current collector | distance | at burning | | | | | | | |
| | | containing | layer-containing | from | temperature | Composition (% by atom) | | | | | | Cycling |
| | | regions | material | border | (850° C.) | Li | V | Al | Ti | P | O | characteristics |
| Example 15 | Positive electrode | Present | None | 1 μm | 1 hour | 2.55 | 1.50 | 0.05 | 0.45 | 3.00 | 12 | B |
| | active material layer | | | | | | | | | | | |
| | Solid electrolyte | | | | | 1.00 | 0.95 | 0.10 | 1.40 | 2.90 | 12 | |
| | layer | | | | | | | | | | | |
| | Negative electrode | | | | | 2.55 | 1.50 | 0.05 | 0.45 | 3.00 | 12 | |
| | active material layer | | | | | | | | | | | |
| Example 16 | Positive electrode | Present | None | 1 μm | 1 hour | 2.55 | 1.50 | 0.05 | 0.45 | 3.00 | 12 | B |
| | active material layer | | | | | | | | | | | |
| | Solid electrolyte | | | | | 1.00 | 0.30 | 0.12 | 1.90 | 2.80 | 12 | |
| | layer | | | | | | | | | | | |
| | Negative electrode | | | | | 2.55 | 1.50 | 0.05 | 0.45 | 3.00 | 12 | |
| | active material layer | | | | | | | | | | | |
| Example 17 | Positive electrode | Present | None | 1 μm | 1 hour | 2.55 | 1.50 | 0.05 | 0.45 | 3.00 | 12 | B |
| | active material layer | | | | | | | | | | | |
| | Solid electrolyte | | | | | 1.00 | 0.05 | 0.12 | 1.60 | 3.20 | 12 | |
| | layer | | | | | | | | | | | |
| | Negative electrode | | | | | 2.55 | 1.50 | 0.05 | 0.45 | 3.00 | 12 | |
| | active material layer | | | | | | | | | | | |
| Example 18 | Positive electrode | Present | None | 1 μm | 1 hour | 2.55 | 1.50 | 0.05 | 0.45 | 3.00 | 12 | B |
| | active material layer | | | | | | | | | | | |
| | Solid electrolyte | | | | | 1.00 | 0.05 | 0.12 | 1.70 | 3.00 | 12 | |
| | layer | | | | | | | | | | | |
| | Negative electrode | | | | | 2.90 | 2.00 | 0.00 | 0.00 | 3.00 | 12 | |
| | active material layer | | | | | | | | | | | |
| Comparative | Positive electrode | None | None | — | 1 hour | 2.90 | 2.00 | 0.00 | 0.00 | 3.00 | 12 | C |
| Example 1 | active material layer | | | | | | | | | | | |
| | Solid electrolyte | | | | | 1.00 | 0.05 | 0.12 | 1.70 | 3.00 | 12 | |
| | layer | | | | | | | | | | | |
| | Negative electrode | | | | | 2.90 | 2.00 | 0.00 | 0.00 | 3.00 | 12 | |
| | active material layer | | | | | | | | | | | |

Next, a material in the form of a paste that served as the first external terminal 5 was applied to a side surface of the layered body 4 from which an end surface of the positive electrode current collector layer 1A was exposed, thereby forming a terminal electrode layer. Also, a material in the form of a paste that served as the second external terminal 6 was applied to a side surface of the layered body 4 from which an end surface of the negative electrode current collector layer 2A was exposed, thereby forming a terminal electrode layer. In Examples 1 to 18 and Comparative Example 1, Cu was used as a material for the terminal electrode 5 (6). Thereafter, the layered body 4 with the terminal electrode layer formed on the side surface was sintered to form the terminal electrode 5 (6), thereby obtaining the all-solid-state batteries.

For the all-solid-state batteries in Examples 1 to 18 and Comparative Example 1, whether or not Cu-containing regions were formed at the grain boundaries that formed the active material layers that were present near the current collector layer 1A (2A) was examined by the aforementioned method. The results are shown in Tables 1 to 3.

Also, the shortest distance between the border of the current collector layer 1A (2A) and the active material layer and the Cu-containing region that extended from the border toward the side of the active material layer and formed in the furthest location was examined by the aforementioned method. The results are shown in Tables 1 to 3.

Also, cycling characteristics of the all-solid-state batteries in Examples 1 to 18 and Comparative Example 1 were examined by the method described below. The results are shown in Tables 1 to 3.

### “Cycling Characteristics Test”

Charging and discharging was assumed to be one cycle, a 100-cycle charging and discharging test was conducted, and evaluation was made using the following criteria.
A: The capacity maintenance rate after 100 cycles was equal to or greater than 90%.
B: The capacity maintenance rate after 100 cycles was equal to or greater than 80%.
C: The capacity maintenance rate after 100 cycles was less than 80%.

As shown in Tables 1 to 3, the Cu-containing regions were formed at the grain boundaries that were present near the current collector layer 1A (2A) in the all-solid-state batteries in Examples 1 to 18. In regard to the all-solid-state batteries in Examples 1 to 18, the results of the cycling characteristics test were A or B, and satisfactory cycling characteristics were achieved.

Meanwhile, no Cu-containing regions were formed in Comparative Example 1. This was because burning was performed in an atmosphere of a higher oxygen partial pressure of 2×10⁻¹⁰ atm than that in Example 1 at 400 to 850° C. and Cu in the electrode layer at the end portion oxidized and dispersed when the temperature was raised from room temperature to 400° C. was not reduced to metal Cu in Comparative Example 1.

In Comparative Example 1 in which no Cu-containing regions were formed, the result of cycling characteristics was C, and sufficient cycling characteristics were not achieved.

### Experiment Example

A paste was applied to a base material made of a PET film by a doctor blade method and is then dried, thereby forming a first layer in the form of a sheet with the thickness of 20 μm with a composition that is same as that of the solid electrolyte layer in Example 2 shown in Table 1. Next, a paste is printed on the first layer by screen printing and is then dried, thereby forming a second layer with the thickness of 4 μm and with the composition that is the same as that of the positive electrode active material layer and the negative electrode active material layer in Example 2 shown in Table 1. Then, a paste was printed on the second layer by screen printing and was then dried, thereby forming a third layer with a thickness of 4 μm that contained 2.0% by mass of LiVOPO₄ and was made of Cu. Thereafter, the base material was peeled off, thereby producing a unit including the first layer, the second layer, and the third layer.

Also, fifteen first layers were formed, and all of them were laminated (300 μm). Thereafter, the unit was laminated on the fifteen laminated first layers, thereby obtaining a specimen.

As a heat treatment, a treatment of raising the temperature to a room temperature to 400° C. in an atmosphere of an oxygen partial pressure of 2×10⁻¹⁰ atm, further raising the temperature to 400 to 850° C. in an atmosphere of an oxygen partial pressure of 5×10⁻¹⁵ atm, and maintaining the specimen for 1 hour in an atmosphere of an oxygen partial pressure of 5×10⁻¹⁵ atm at a temperature of 850° C. was performed on the obtained specimen. Note that the oxygen partial pressure was a numerical value measured using an oxygen concentration meter at a sensor temperature of 700° C.

### “Element Mapping Result”

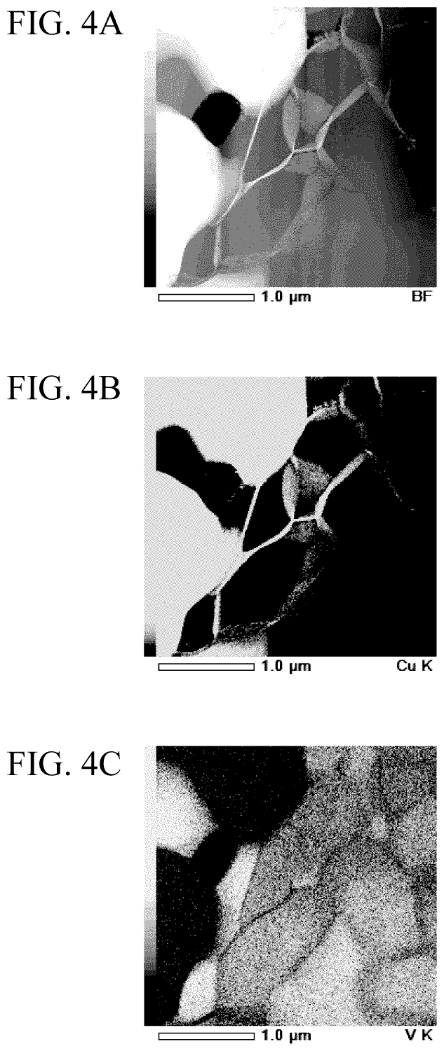

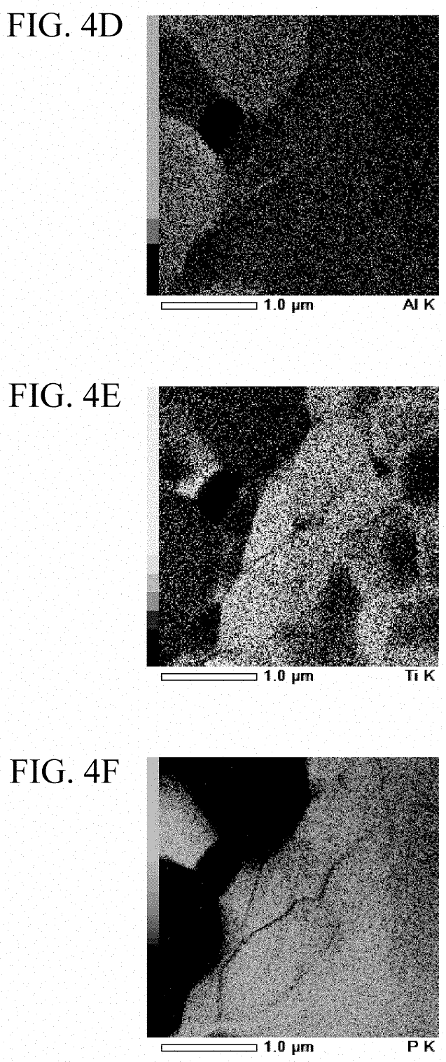

The specimen after the heat treatment was cut, and energy dispersive X-ray spectroscopy (EDS) was performed on grain boundaries of the second layer that was present near the third layer in the cut surface. An image of an observed field of view is shown in FIG. 4A, and obtained results of element mapping of Cu, V, Al, Ti, and P are shown in FIGS. 4B to 4F.

As shown in FIGS. 4A to 4F, it was confirmed that the Cu-containing regions that contained Cu at high concentration were formed at the grain boundaries that were present near the third layer.

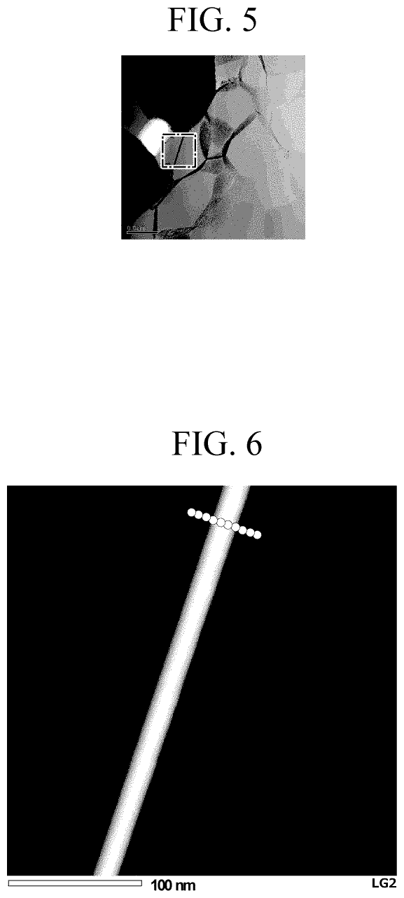

Also, scanning electron microscope (SEM) observation was conducted on the specimen after the heat treatment in the same field of view as those in FIGS. 4A to 4F. FIG. 5 is a scanning electron microscope (SEM) photo of the specimen after the heat treatment in the same field of view as those in FIGS. 4A to 4F. FIG. 6 is an enlarged photo showing a part of FIG. 5 in an enlarged manner and is an enlarged photo within the frame of the dashed line in FIG. 5.

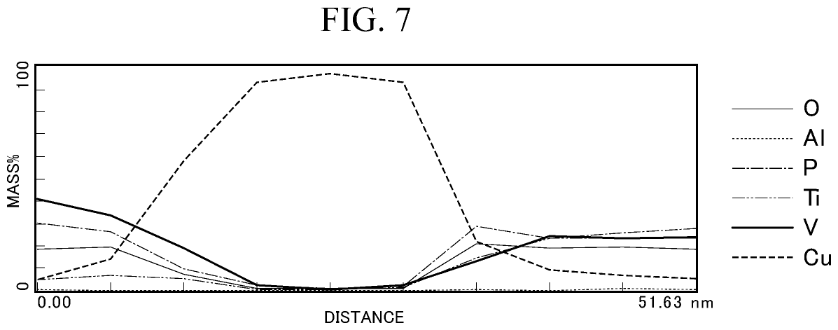

Energy dispersive X-ray spectroscopy (EDS) was conducted at the location represented with circles in FIG. 6. The result is shown in Table 4 and FIG. 7. FIG. 7 is a graph showing a relationship between a distance between an origin (the location of 0.00), which is assumed to be at the leftmost location among the locations represented with the circles in FIG. 6, and locations represented with the other circles and element concentration at each location. Table 4 shows measurement results of the element concentration at the location of 22.95 nm from the origin.

TABLE 4

| Element | % by mass | % by number of atoms |
|---|---|---|
| O K | 0.8 | 3 |
| Al K | 0 | 0.1 |
| P K | 1 | 2 |
| Ti K | 0.5 | 0.6 |
| V K | 0.7 | 0.8 |
| Cu K | 97 | 93.5 |

As shown in Table 4 and FIG. 7, it was recognized that the white portion shown in FIG. 6 was a Cu-containing region containing Cu at a high concentration and the amount of Cu in the Cu-containing region was equal to or greater than 90% by mass.

### REFERENCE SIGNS LIST

1 Positive electrode layer (electrode layer)

1A Positive electrode current collector layer (current collector layer)

1B Positive electrode active material layer (active material layer)

2 Negative electrode layer (electrode layer)

2A Negative electrode current collector layer (current collector layer)

2B Negative electrode active material layer (active material layer)

3 Solid electrolyte layer

4 Layered body

5 First external terminal (terminal electrode)

6 Second external terminal (terminal electrode)

10 All-solid-state lithium ion secondary battery (all-solid-state battery)

21 Cu-containing region

22 Particle

1. An all-solid-state lithium ion secondary battery comprising:
a plurality of electrode layers that are laminated with a solid electrolyte layer therebetween, a current collector layer and active material layer being laminated in each of the electrode layers,
wherein the current collector layers contain Cu, and
Cu-containing regions are formed at grain boundaries that are present near the current collector layer among grain boundaries of particles that form the active material layer.

2. The all-solid-state lithium ion secondary battery according to claim 1, wherein the current collector layer contain at least one selected from the group consisting of V, Fe, Ni, Co, Mn, and Ti.

3. The all-solid-state lithium ion secondary battery according to claim 1, wherein a shortest distance between; a border of the current collector layer and the active material layer; and a Cu-containing region, which extends from the border toward a side of the active material layers and formed in a furthest location from the boundary is equal to or greater than 0.1 μm and less than a half of a distance between adjacent current collector layers.

4. The all-solid-state lithium ion secondary battery according to claim 1, wherein the solid electrolyte layer contain a compound represented by Formula (1) below:
Li_{f}V_{g}AlₕTiᵢPⱼO₁₂ (1)
wherein f, g, h, i, and j in Formula (1) represent numbers that satisfy 0.5≤f≤3.0, 0.01≤g<1.00, 0.09<h≤0.30, 1.40<i≤2.00, and 2.80≤j≤3.20, respectively.

5. The all-solid-state lithium ion secondary battery according to claim 1, wherein at least one electrode layer include an active material layer that contains a compound represented by Formula (2) below:
LiₐV_{b}Al_{c}Ti_{d}PₑO₁₂ (2)
wherein a, b, c, d, and e in Formula (2) represent numbers that satisfy 0.5≤a≤3.0, 1.20<b≤2.00, 0.01≤c<0.06, 0.01≤d<0.60, and 2.80≤e≤3.20, respectively.

6. The all-solid-state lithium ion secondary battery according to claim 1, wherein a relative density of the electrode layer and the solid electrolyte layer is equal to or greater than 80%.
